(19) United States
(12) Patent Application Publication
(10) Pub. No.: US 2003/0180593 A1
(43) Pub. Date: Sep. 25, 2003

(54) Electrochemical device using fuel cell energy

(76) Inventor: Yuji Kohara, Hiroshima (JP)

Correspondence Address: BIRCH STEWART KOLASCH & BIRCH, PO BOX 747, FALLS CHURCH, VA, 22040-0747, US

(21) Appl. No.: 10/141,580

(22) Filed: May 9, 2002

(30) Foreign Application Priority Data
Mar. 22, 2002 (KR) 2002-0015630

(51) Int. Cl. H01M 8/10; H01M 8/04; H01M 8/02

(52) U.S. Cl. 429/32; 429/21; 429/37

(57) ABSTRACT

An electrochemical device using fuel energy, including a plurality of ion cases containing energy converting polar plate respectively, and disposed within a housing, and a DC high voltage power service input for connecting with each ion case and finally, connecting to the protected reversing push member, whereby the electrochemical device has an improved energy converting ratio, excellent durability and light weight thereof.

### BACKGROUND OF THE INVENTION

1. Field of the Invention

The present invention relates to an electrochemical device using fuel cell energy, and more particularly, to an improved electrochemical device containing a plurality of improved energy converting polar plate for promoting efficiency of the energy converting ratio, and having excellent durability and light weight thereof, so as to generate electric current.

2. Description of Related Art

Various types of electrochemical devices including fuel cells are known in the art. Generally, the electrochemical device using fuel cell energy converts chemicals, a fuel and an oxidant, into direct-current electricity. Therefore, the electrochemical device using fuel cell energy has an advantage of power generating system without a broiler, a turbine, or a generator. However, it is difficult to get effective electrochemical device using fuel cell energy since such conventional electrochemical devices suffer from many problems such as, lower energy converting ratio, poor durability, and heavy weight thereof.

### SUMMARY OF THE INVENTION

Accordingly, it is an object of the present invention to provide an improved electrochemical device using fuel cell energy which eliminates the above problems encountered with conventional electrochemical devices using fuel cell energy.

Another object of the present invention is to provide an electrochemical device using fuel cell energy having high efficiency of the energy converting ratio, excellent durability and lightweight thereof.

A further object of the present invention is to provide an electrochemical device using fuel cell energy which includes a plurality of ion cases containing an improved energy converting polar plate disposed within a housing containing a DC high voltage power service input, and a protected reversing push member for connecting the plurality of ion cases whereby the electrochemical device using fuel cell energy can be used in internal or external combustion engines, and electric appliances.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of an ion case containing an energy converting polar plate of an electrochemical device using a fuel cell energy according to the present invention; and

FIG. 2 is a perspective view of the electrochemical device using a fuel cell energy according to the present invention.

### DETAILED DESCRIPTION OF THE PREFERRED EMBODIMENTS

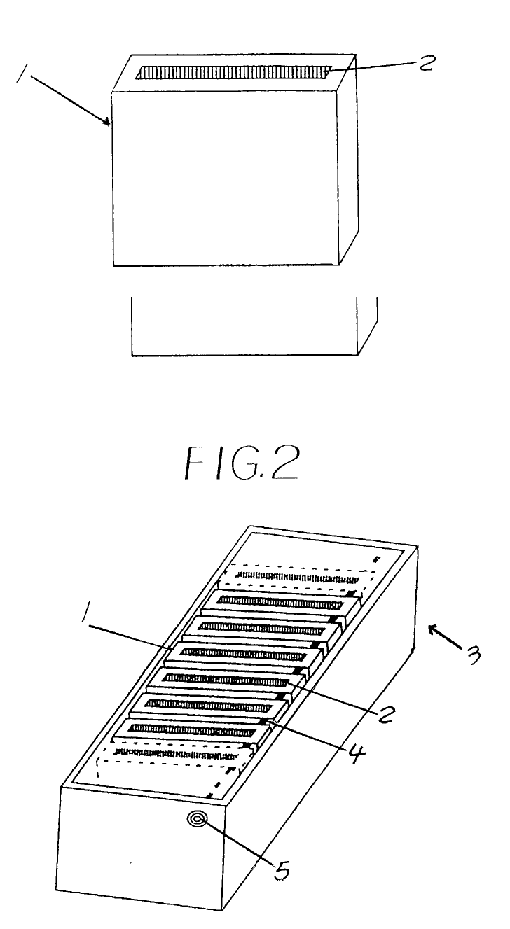

Referring now in detail to the drawings for the purpose of illustrating preferred embodiments of the present invention, the electrochemical device using fuel cell energy as shown in FIGS. 1 and 2, comprises a housing 3 including a plurality of ion cases 1, wherein each case 1 has an energy converting polar plate 2 inserted thereinto in taking a network style distribute electric source. By inserting the energy converting polar plate 2 into the ion case 1, efficiency of energy converting ratio is promoted highly and leakage of invalid energy is protected effectively.

As shown in FIG. 2, the plurality of ion cases 1 containing the energy converting polar plate 2, respectively, in the housing 3, are connected through a protected reversing push member 4. A DC high voltage power service input 5 is disposed on one side of the housing 3 for protecting from electric contact block. Also, the protected reversing push member 4 is finally connected to the DC high voltage power service input 5. The housing 3 has a negative polarity and the DC high voltage power service input 5 has a positive polarity.

The conventional network style distribute electric source can be existed in a personal computer and a flashlight which are small size and light weight, and in a fuel cell of a car power generator as various types. An automobile containing the fuel cell is called a hybrid and has an advantage of reduction of by-products' exhaust such as No, SO₂ and CO₂, when compared with automobiles using gasoline, light oil, and LPG.

However, the electrochemical device using fuel cell energy according to the present invention can be effectively increased production efficiency for increasing storage quantity and extending life period time thereof. Also, if the electrochemical device using fuel cell energy according to the present invention uses in the automobile power generator, the present electrochemical device can be reduced by-products' exhaust such as, No, SO₂ and CO₂. Therefore, it increases about 30% of fuel ratio when compared with a conventional automobile. If the electrochemical device using fuel cell applies to domestic and industrial power generators, as well as internal and external combustion engines, it can be started a kind of energy revolution.

Accordingly, in the present invention, the excellent and improved energy converting polar plate 2 disposed in the ion cases 1, respectively, of the housing 3, has advantages such as efficiency of energy converting ratio, excellent durability, and lightweight thereof.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electrochemical device using fuel energy comprising:
a housing;
a plurality of ion cases disposed within said housing,
an energy converting polar plate disposed within each of said ion cases;
a DC high voltage power service input disposed on one side of said housing; and
a protected reversing push member disposed between said ion cases in the housing for connecting with each ion case and finally connecting to the DC high voltage power service input member, whereby the electrochemical device has improved energy converting ratio, excellent durability and light weight thereof.

2. The electrochemical device using fuel energy of claim 1, wherein said electrochemical device uses a network style to distribute electric source.
